(19) United States
(12) Patent Application Publication
(10) Pub. No.: US 2002/0038249 A1
(43) Pub. Date: Mar. 28, 2002

(54) System and method for facilitating information requests

(76) Inventors: F. William Daugherty, Old Greenwich, CT (US); Peter Shapiro, New York, NY (US)

Correspondence Address: BUCKLEY, MASCHOFF & TALWALKAR, & ALLISON LLC, 111 ELM STREET, NEW CANAAN, CT, 06840, US

(21) Appl. No.: 09/963,246

(22) Filed: Sep. 26, 2001

Related U.S. Application Data
(60) Provisional application No. 60/235,645, filed on Sep. 26, 2000.

(51) Int. Cl. G06F 17/60

(52) U.S. Cl. 705/14

(57) ABSTRACT

An Internet Website or other network-based service provides a user several choices as to additional sources of information. The user may select from among the sources of information while viewing an advertisement or other content displayed by the Internet website or other network-based service.

### FIELD OF THE INVENTION

The present invention relates to a system and method for facilitating information requests at an Internet website or other network-based service accessible for on-line communications.

### BACKGROUND OF THE INVENTION

A major function of the Internet is to disseminate information. Because each user's information needs are different, the organization of the information distribution function is a critical element in website design. Inevitably, because of the vast amount of information available, it becomes necessary to organize any website in some sort of hierarchical fashion in which a user is led through various layers organized on a basis such as relevance or increasing amount of detail.

Often, the user does not have the time or inclination to work through all this detail and gives up before getting the specific information desired.

At least in cases where the information sought relates to products or services that are offered for sale, there is substantial incentive on the part of the website operator to provide the user the information he or she wants. The present invention is directed to such a system.

### SUMMARY OF THE INVENTION

A preferred embodiment of the invention provides the user several choices as to additional sources of information. For example, he or she may choose to obtain such information at once, or by email or by conventional delivery services. Whatever the choice, the invention provides personalized responses to the user in an integrated system that also tracks and reports on the user's choices.

### BRIEF DESCRIPTION OF THE DRAWINGS

FIG. 1 is a block diagram of an Internet-based sweepstakes system of a preferred embodiment of the present invention.

FIG. 2 is a web page used in a preferred embodiment of the present invention.

FIG. 3 is a flow chart illustrating the operation of a preferred embodiment of the present invention.

FIGS. 4-8 are additional web pages used in preferred embodiment of the present invention.

### DETAILED DESCRIPTION

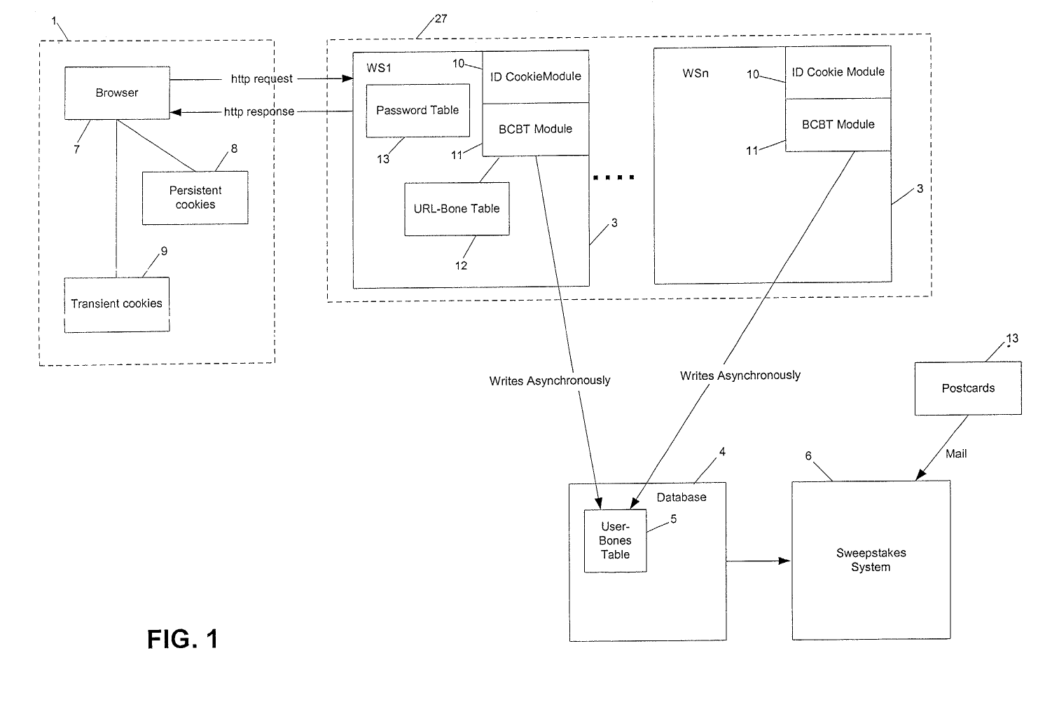

FIG. 1 is reproduced from co-pending application Ser. No. 09/412,013, filed Oct. 4, 1999 for “Network-Based Sweepstakes System and Method”, which is hereby incorporated by reference. It depicts the basic hardware setup of an illustrative system in which the present invention may be used. A user at personal computer (PC) 1 connects, preferably via the Internet, to host 2. PC 1 contains a processor, such as Pentium II, and memory. Host 2 is comprised of one or more web servers 3, such as Netscape Enterprise Webservers. The web servers 3 are in turn connected to database server 4, containing database 5. Database server 4 is connected, via a dial-up connection, local or wide area network, or other means, to sweepstakes system 6.

Briefly, PC 1 contains and executes browser 7, which enables PC 1 to communicate with a web server 3, and contains various persistent and transient cookies 8 and 9. Cookies 8 and 9 are set by web server 3; persistent cookies 8 are typically set when a user registers with host 2 and transient cookies are typically set when the user subsequently accesses host 2. Browser 7 and cookies 8 and 9 reside in memory in PC 1. In a preferred embodiment, host 2 hosts a portal-type website, i.e., a website that provides hyperlinks to various services, various webpages in the website and various other websites and services. When PC 1 connects to a web server 3, it downloads a webpage, which is displayed by browser 7. The webpage contains hyperlinks that are typically highlighted in some manner by browser 7. When a user selects a hyperlink, by for example clicking on it with his or her mouse, PC 1 sends a URL (uniform resource locator) corresponding to the hyperlink to webserver 3.

In accordance with the invention described in the co-pending application, a user is awarded points, referred to herein as “bones,” for clicking on hyperlinks. The hyperlinks may represent, in the user's view, a request for a webpage or a portion of a webpage or a request for a service or other feature of a website. For example, a user may be awarded points for performing some task, such as making a webpage on host 2 the user's homepage or signing up for a service, such as email. In this case, the user may have to click on one or more hyperlinks to complete the task, with the last hyperlink, for example, indicating that the task has been completed. Alternatively, after the user has completed the task, host 2 can send a redirection response to PC 1, causing PC 1 to automatically request a URL associated with the completion of the task. Advantageously, different numbers of points may be awarded for clicking on different hyperlinks in accordance with a URL-Bone Table 12.

Users are automatically enrolled in daily, monthly and yearly sweepstakes and their chances of winning depend on the number of bones they have collected over the corresponding time period. Transient cookies 9 on PC 1 store the daily, monthly and yearly bone totals. A javascript on PC 1 displays a “bone box” on PC 1, containing the user's first name and daily, monthly and yearly bone totals as stored in cookies 9.

Each webserver 3 executes ID cookie module 10 and BCBT (bone counting bone tracking) module 11. ID cookie module 10 generates a unique user ID when a user registers and writes the ID in a persistent cookie, called ssuid, on PC 1. The unique user ID can be generated, for example, using Vignette Corporation's StoryServer Software package, which guarantees that the ID is specific and unique for each user and produces IDs that are very difficult to generate without using the package (i.e., the IDs are difficult to “spoof”). ID cookie module 10 also generates a unique user number, associated with each unique user ID, and writes the user number in a persistent cookie, called user_num, on PC 1. The user_num cookie is used as an index to conveniently access URL-Bone Table 12.

As described in the co-pending application, BCBT module 11 performs several functions including determining whether the user interacting with the host system is a registered user and setting the Register_flag cookie on PC 1 to ‘Y’ (yes) or ‘N’ (no) accordingly, causing the javascript on PC 1 to display a message directing the user to register if he or she is not a registered user.

The system of FIG. 1 operates as follows. A user at PC 1 connects to a web server 3 in host 2 by, for example, typing a url associated with host 2 in browser 7. Host 2 executes a module that generates a webpage and downloads it to PC 1. Web server 3 checks if ssuid and user_num cookies exist for the user by requesting these cookies from PC 1. If browser 7 does not have cookies enabled, PC 1 displays an appropriate error message informing the user that cookies must be enabled. As mentioned above, the ssuid and user_num cookies are persistent cookies stored on PC 1 containing a unique user ID and user number, respectively, for a registered user of the system. If these cookies do not exist, either the user has not yet registered with host system 2 or the cookies were deleted (for example, because there was a fault in PC 1 or the cookies were tampered with). If the user has previously registered, then he signs in by entering his user name and password. Web server 3 verifies the user name and password based on the information in password table 13. If the user name and password is verified, web server 3, creates and sets the ssuid, user_num and Dblndicator cookies in PC 1. The Dblndicator cookie identifies the database server 4 and user_bones table 5 containing information about the user, which is useful if multiple databases are used. Otherwise, web server 3 causes PC 1 to report a sign-in error to the user.

If the user has not been previously registered, he must do so. During registration, ID cookie module 10 on web server 3 creates an entry for the user in password table 13 and creates a unique ssuid and user number for the user. The registration process also collects other information about the user such as the user's age, sex, address and email address.

Following registration, the web server offers the user a screen having a set of hyperlinks to other screens. Each of these other screens may contain additional information sought by the user. More specifically, each hyperlink may identify a product or a service and the screen that is accessed may provide additional information about that product or service. Of particular interest to the present invention, the screens that are accessed may be advertisements for the product or service.

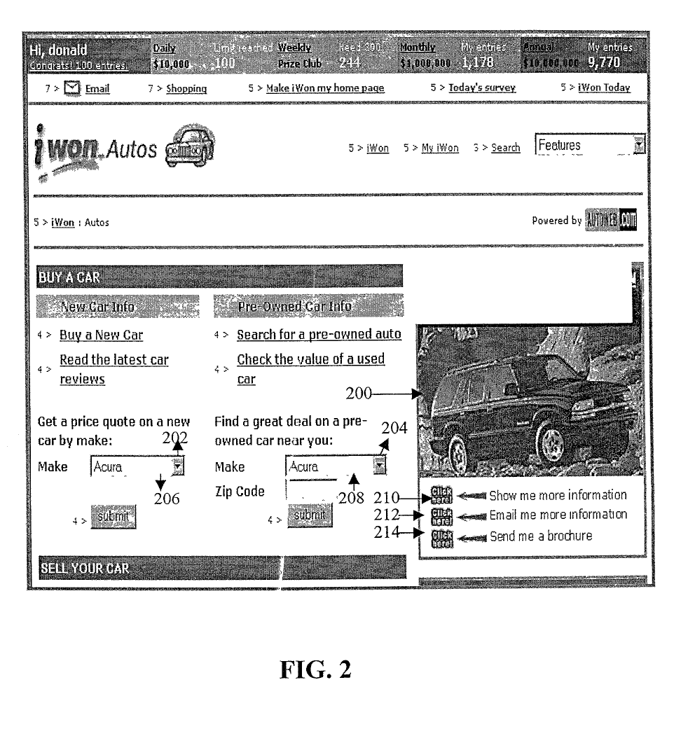

One such example of a screen is shown in FIG. 2 and includes a display 200 of a car as well as selection buttons 202, 204 and scrolling displays 206, 208 for getting price quotes on new and pre-owned cars. As shown in FIG. 2, the display in picture 200 is independent of the content of displays 206, 208. Alternatively, the car shown in display 200 could be the make and model then specified by one of displays 206, 208.

In accordance with the invention, additional information is made available to the user by three selection buttons 210, 212, 214 located under picture 200. Clicking on button 210 causes display of another screen that provides additional information about the car shown in display 200. Clicking on button 212 causes additional information about the car to be sent to the user by email. Clicking on button 214 causes a brochure or some other publication to be sent to the user.

Different techniques can be used to determine which car is shown to the user in display 200. For example, advertisers can buy display time in display 200.

While the three choices of show more information, email more information and send more information are depicted in FIG. 2, other choices are also possible. These may include:

Special deal

Buy now (items purchased by credit card and delivered by mail)

Deliver Now (ordered by credit card and delivered immediately)

Download Now

Stream/See/Listen now

Make a reservation (travel, restaurant, tickets to a show/concert/event)

For each of these choices, the present invention also provides appropriate responses.

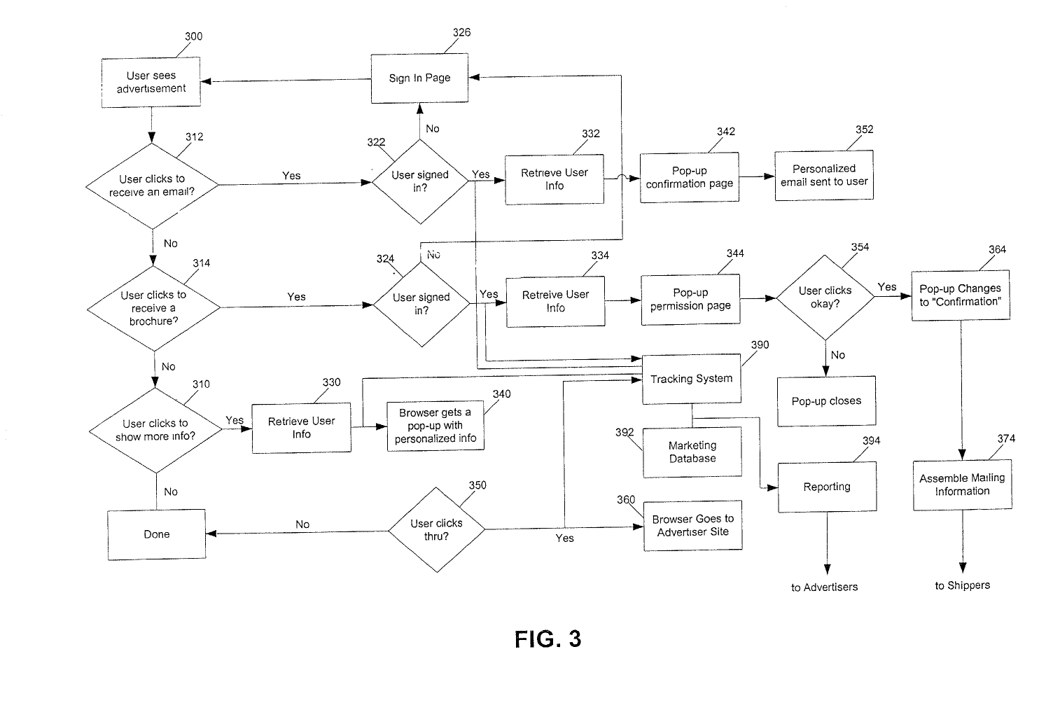

A flow chart illustrating the implementation of the invention in the case of the three choices of FIG. 2 is set forth in FIG. 3.

The three options presented to a user are represented by decision steps 310, 312, 314 on the left-hand side. The web server continually tests at steps 310, 312, 314 if the user has clicked on any of these buttons. If the user clicks on either button 212 or 214, the web server tests at steps 322, 324 if the user has signed in. If he has not, the user is presented at step 326 with a sign in page and upon successfully signing in the user is returned to advertisement 300. If the user has signed in, user information is retrieved at steps 332, 334. In addition, if the user clicks on button 210, this is sensed by the server at step 310 and user information is retrieved at step 330. The user information is available at this point because the user has signed in, thereby identifying himself to the server. Information about the user is stored in database 5 at the time the user initially registers with the server. The particular information retrieved at steps 330, 332, 334 varies with the nature of the information requested. Typically, it includes information such as the user's name so as to personalize any response. In the case of step 332, it includes the user's email address; and in the case of step 334 it includes the user's mailing address. Other demographic information may also be provided to allow further customization of the response provided by the server.

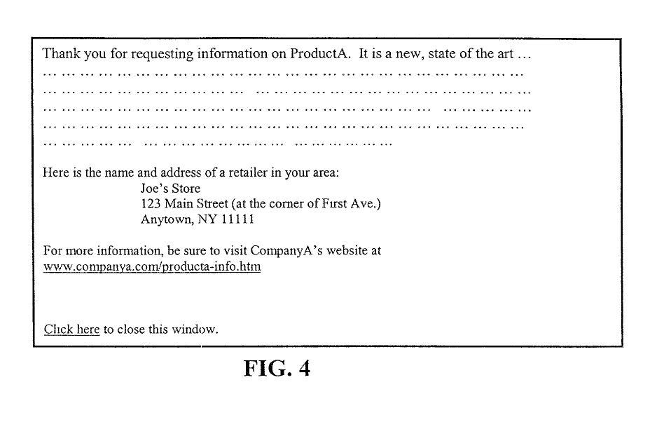

Upon retrieving the user information, the server provides a personalized response to the user. Initially, this response is in the form of an additional screen that acknowledges the request and indicates the action being taken. In the case where the user selected button 310, a pop-up screen such as that of FIG. 4 is displayed at step 340 to provide additional information. Advantageously, the screen also provides information as to where the product or service can be obtained and the address of the supplier's website. Preferably, the screen contain a hyperlink to the supplier's website and the server continually tests at step 350 if the user has checked on this link. If the user does, at step 360 the browser goes to the website specified by the hyperlink.

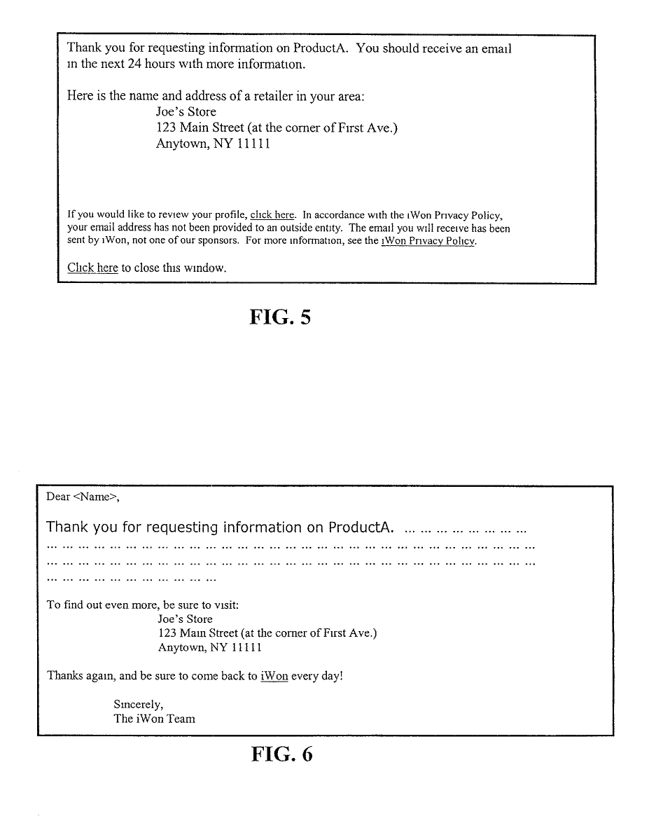

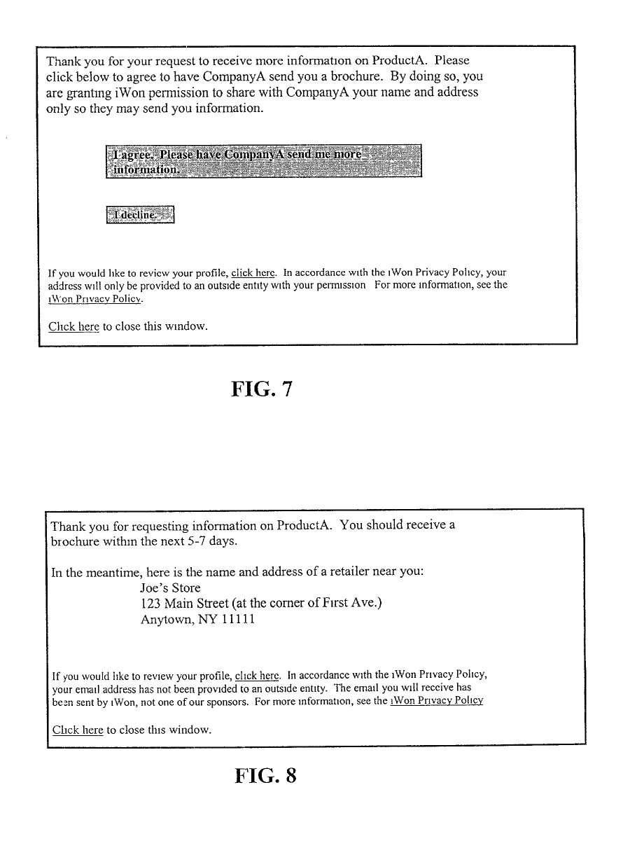

In the case where the user selected button 312, a pop-up screen such as that of FIG. 5 is displayed at step 342 indicating that an email will be sent. Subsequently, a personalized email is sent as at step 352. An example of such an email is shown in FIG. 6. If the user selected button 214, at step 344 the server displays a permission page such as that shown in FIG. 7. This page requests the user's consent to use of his address. The server monitors the user at step 354 for his consent and, upon receiving it, displays at step 364, a confirmation page such as that shown in FIG. 8. The server then generates at step 374 instructions to send the additional information to the user at the appropriate address. Advantageously, such requests for provision of additional information are aggregated at the server and transmitted in batches to the entity responsible for forwarding the additional information to the requesters.

Operation of the system generates enormous amounts of information of interest to advertisers. For example, it will be of interest to advertisers to know which displays produced requests for more information, for email, for brochures, or generated visits to supplier's website and what categories of users were responsible for such requests and visits. This information is accumulated by a tracking system 390 that monitors such activity and collects it in a marketing database.

Advantageously, some of this information can also provide the basis for charging for advertising services. In such case, the data is also reported to the advertisers at step 394.

As indicated above, other types of information requests may also be satisfied using the selection buttons 210, 212, 214. Thus, in addition to the screens shown in FIGS. 4-8, the following screens may be provided:

Special deal—brings up a pop-up with similar info to clicking on one of the iWon POPs in iWon Shopping. The form would be pre-filled with the user's info with only the credit card left blank. We would host this to gain the user's credit card information for the database and then pass, securely, the user's info to the sponsor for confirmation and fulfillment.

Buy now (items purchased by credit card and delivered by mail)—same as “special deal”.

Deliver Now (ordered by credit card and delivered immediately—e.g., Kozmo)—same as “special deal”, only there might be an additional question for delivery instructions.

Download Now—would go straight to a download screen.

Stream/See/Listen now—would launch a RealPlayer or Windows Media Player.

Make a reservation (travel, restaurant, tickets to a show/concert/event) pulls up a pop-up with the specifically pertinent forms.

1. A method for providing information to a user accessing a World Wide Web site, comprising:
serving an advertisement associated with a first World Wide Web site, wherein said advertisement has an associated selectable option that is displayed when said advertisement is displayed, further wherein said selectable option has an associated information delivery process;
receiving an indication of a selection of said selectable option associated with said advertisement; and
providing information associated with said advertisement via said information delivery process.

2. The method of claim 1, wherein said advertisement has at least one subject matter topic associated with it and said information is directed at least in part to said subject matter topic.

3. The method of claim 1, further comprising:
receiving an indication of personal information used during said providing information associated with said advertisement via said information delivery process.

4. The method of claim 1, where said providing information associated with said advertisement via said information delivery process includes at least one of the following:
redirecting a browser to a second World Wide Web site containing said information;
providing a hyperlink to a second World Wide Web site, wherein said second World Wide Web site contains said information;
emailing said information;
providing an indication that said information will be provided in an email message;
serving said information as part of a new advertisement associated with said first World Wide Web site;
serving said information as part of said first World Wide Web site;
facsimileing said information; and
mailing said information to a postal address.

5. The method of claim 1, wherein said indication of a selection of said selectable option associated with said advertisement is received from a user accessing said first World Wide Web site and further comprising:
determining personal information associated with said user.

6. The method of claim 5, further comprising:
providing at least a portion of said personal information associated with said user to a third party.

7. The method of claim 5, wherein said information delivery process is based at least in part on said personal information.

8. The method of claim 5, wherein said personal information includes at least one of the following:
an email address;
a postal address;
an age;
a telephone number;
a facsimile number;
a user preference;
a credit card number; and
a user identifier.

9. The method of claim 5, wherein said determining personal information associated with said user includes:
receiving an indication of said personal information associated with said user.

10. The method of claim 1, further comprising:
providing an indication of said selection of said selectable option to a third party.

11. The method of claim 1, wherein said information associated with said advertisement includes a notice that additional information will be provided by a third party.

12. The method of claim 1, wherein said information associated with said advertisement includes a request for consent to receive additional information.

13. The method of claim 11, further comprising:
receiving an indication of a consent to receive said additional information.

14. The method of claim 11, further comprising:
providing said additional information.

15. The method of claim 1 1, further comprising:
providing a notice that said additional information will be provided by a third party.

16. The method of claim 11, wherein said information associated with said advertisement includes a request for consent to receive additional information and a notice that said additional information will be provided by a third party.

17. A method for providing information to a user accessing a World Wide Web site, comprising:
serving a displayable item associated with a World Wide Web site, wherein said displayable item has at least two associated selectable options and each of said two selectable options has an associated information delivery process;
receiving an indication of a selected one of said at least two selectable options; and
providing information associated with said displayable item via said information delivery process associated with said selected one of said at least two selectable options.

18. The method of claim 17, wherein each of said at least two associated selectable options has a different information delivery process associated with it.

19. The method of claim 17, wherein said displayable item includes an advertisement.

20. The method of claim 17, wherein said displayable item includes at least one of the following:
an image;
a hyperlink associated with at least one of said two selectable options;
a banner;
a button; and
a badge.

21. A method for facilitating delivery of third party information to a visitor of a World Wide Web site, comprising:
displaying a displayable item on a World Wide Web site, wherein said displayable item is associated with a third party and has an associated selectable option, further wherein said selectable option has an associated information delivery process;
receiving an indication of a selection of said selectable option associated with said displayable item; and
providing an indication of said selection to said third party.

22. The method of claim 21, further comprising:
providing an indication of said information delivery process to said third party.

23. The method of claim 21, further comprising:
providing contact information to said third party for use in said information delivery process.

24. The method of claim 23, wherein said contact information includes at least one of the following:
an email address;
a postal address;
a telephone number;
a facsimile number;
a user preference;
a credit card number; and
a user identifier.

25. A method for facilitating information transfer to a user accessing a World Wide Web site, comprising:
displaying a displayable item associated with a first World Wide Web site, wherein said displayable item has an associated selectable option, further wherein said selectable option has an associated information delivery process;
receiving an indication of a selection of said selectable option associated with said displayable item; and
providing an indication of said selection to a second World Wide Web site.

26. A system for providing information, comprising:
means for distributing an advertisement associated with a World Wide Web site, wherein said advertisement has an associated selectable option that is displayed when said advertisement is displayed, further wherein said selectable option has an associated information delivery process;
means for detecting an indication of a selection of said selectable option associated with said advertisement; and
means for transmitting information associated with said advertisement via said information delivery process.

27. An article of manufacture, comprising:
computer program means for distributing a displayable item associated with a World Wide Web site, wherein said displayable item has at least two associated selectable options and each of said two selectable options has an associated information delivery process;
computer program means for detecting an indication of a selected one of said at least two selectable options; and
computer program means for transmitting information associated with said displayable item via said information delivery process associated with said selected one of said at least two selectable options.
